(19) United States
(12) Patent Application Publication
(10) Pub. No.: US 2010/0327614 A1
(43) Pub. Date: Dec. 30, 2010

(54) Shovel lifting/throwing device

(75) Inventor: Christopher Lloyd Bush, Courtice (CA)

Correspondence Address: Christopher Bush, 197 George Reynolds Drive, Courtice, ON, L1E 2W2, omitted

(73) Assignee: Mr. Christopher Lloyd Bush, Courtice (CA)

(21) Appl. No.: 12/549,330

(22) Filed: Aug. 27, 2009

(30) Foreign Application Priority Data
Jun. 30, 2009 (CA) 2670461

(51) Int. Cl. E01H 5/02; A01B 1/02

(52) U.S. Cl. 294/59

(57) ABSTRACT

A shovel lifting/throwing device for removing material from a surface requiring little effort by the user to lift and throw the material, the shovel having a blade and a handle wherein there is a lifting/throwing device, comprised of a lifting arm pivotally fastened to the middle section of the handle running down generally parallel the handle to the under side of the shovel blade in the vicinity of the surface, a hand grip located above the lifting arm moves up the handle as the user begins to lift the load, it being connected by a cable to a mechanism, actuating the mechanism that engages the lifting arm, pivoting the lifting arm out and away from the under side of the blade into contact with the surface and lifting the blade off the surface, greatly reducing the effort required by the user to lift and throw the load.

### FIELD OF THE INVENTION

The present invention is in the field of devices for manually removing material from a surface and particularly reducing the amount of stress put on the users body by incorporating a conventional shovel with a shovel lifting/throwing device.

### BACKGROUND OF THE INVENTION

Various shovels are available for manually removing material from a surface by incorporating a lifting and or throwing device with a conventional shovel.

The conventional shovel with a elongated handle and shovel blade at the lower end which can be used to push, lift and throw the material. The lifting and throwing action of these conventional shovels involves bending forward and grasping the handle midway down, then lifting the shovel at the same time exerting a forward or side motion to throw the material. Often causing back pain very heavy breathing and accelerated heart rate in many people.

There have been many devices designed to alleviate the problem of lifting the material. Prior art attempts to reduce these strains include shovels with a device located between the blade and the top of the handle extending down to the surface acting as the fulcrum, making the shovel a lever for lifting material buy making a rearward pull and pushing down on the top end of the handle, notably Evertsen U.S. Pat. No. 4,881,332 and Champi U.S. Pat. No. 5,732,933. These require the user to adapt to a unfamiliar movement and limits use when lifting material on top of piles higher than the shovels range of movement, as well as having no adequate means of transporting the load along the surface. Noonan U.S. Pat. No. 7,111,418. In which a large wheel is incorporated that acts as the fulcrum enabling the transportation of material along the surface, but still the user has to adapt to an unfamiliar movement and limits its use when the need to lift material on top of large piles, being the overall size of the device makes lifting more difficult, as well the storage.

### SUMMARY OF INVENTION

I have found that these disadvantages may be overcome by providing a shovel lifting/throwing device, that when used in conjunction with the conventional shovel will greatly reduce the amount of stress put on the users body, particularly the back, heart and lungs during and after the act of shovelling.

It is the primary objective of the present invention to, when incorporated with a conventional shovel, provide a device that is compact in size, able to aid in lifting and throwing material in a manner that is a familiar movement, requires much less energy and greatly reduces the stress put on the users body.

The present invention, with the user holding the shovel in a conventional manner with one hand at the top end of the handle and the other hand midway down the handle on the hand grip. It is possible to easily lift and throw the material by pushing the shovel along the surface and following through to lift and throw the material, in the same manner as one would a conventional shovel. But as the user begins to lift the material the hand grip begins to slides up the handle, actuating the mechanism to engage the lifting arm to raise the blade off the surface, accelerating the blade up as the lifting arm approaches maximum lift, launching the material upward and with the forward momentum the material is thrown up and forward. The lifting arm than returns to a non-working position as the user returns shovel blade to the surface.

When lifting material when against a large pile and forward momentum is halted, the user lifts on the hand grip actuating a mechanism that pushes out on the lifting arm raising the shovel blade off the surface and accelerating as the lifting arm approaches maximum lift. With this momentum and the user being in a more upright position, the user continues to lift and throw the material to the top of the pile with much less effort.

### BRIEF DESCRIPTION OF THE DRAWINGS

The applicant's shovel lifting/throwing device will be further understood from the following description with reference to the drawings in which:

FIG. 1 is a perspective view of the embodiment of the invention in this case in the form of a snow shovel.

FIG. 2 is a combined sequences of operation diagram, indicating the shovel lifting/throwing device in relations to the user at different sequences during operation.

FIG. 3 A is an operational diagram indicating shovel with a load in relations to the user at the base of a large pile of material.

FIG. 3 B is an operational diagram indicating shovel with a load in relations to the user at the top of the assisted lift from the base of a large pile of material.

FIG. 3 C is an operational diagram indicating shovel throwing a load in relations to the user onto a large pile of material.

FIG. 4 A is a close up right side view of the present invention in the non-working position, showing the various main components thereof.

FIG. 4 B is a close up right side view of the present invention in the maximum lifting position, showing various main components thereof.

FIG. 5 is a up close straight on back view of the present invention in the non-working position, showing various main components thereof.

FIG. 6 is a dismantled perspective view of the present invention showing all the main and related components thereof.

FIG. 7 is a perspective view of stops shown in FIG. 6.

FIG. 8 is a perspective view of a guide track shown in FIG. 6.

FIG. 9 is a perspective view of a hand grip shown in FIG. 6 and all the components thereof.

FIG. 10 is a perspective view of a steel cable shown in FIG. 6 and all the components thereof.

FIG. 11 is a perspective view of a bracket shown in FIG. 6 and all the components thereof.

FIG. 12 is a perspective view of a mechanism shown in FIG. 6 and all the components thereof.

FIG. 13 is a perspective view of a lifting arm shown in FIG. 6 and all the components thereof.

FIG. 14 is a perspective view of a bracket shown in FIG. 6 and all the components thereof.

FIG. 15 is a perspective view of optional wheels shown in FIG. 6 and all the components thereof.

FIG. 16 is a perspective view of a spring shown in FIG. 6 and all the components thereof.

FIG. 17 is a perspective view of a cover shown in FIG. 6 and all the components thereof.

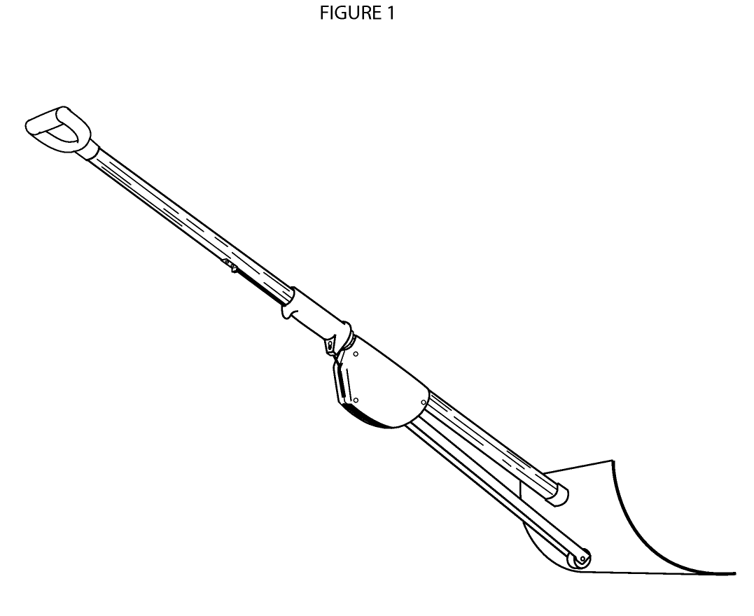

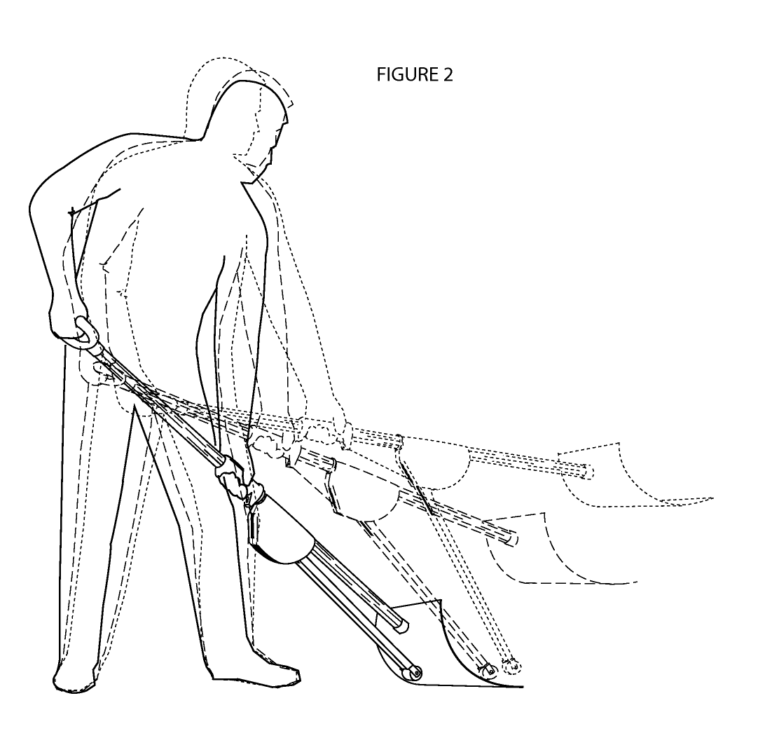

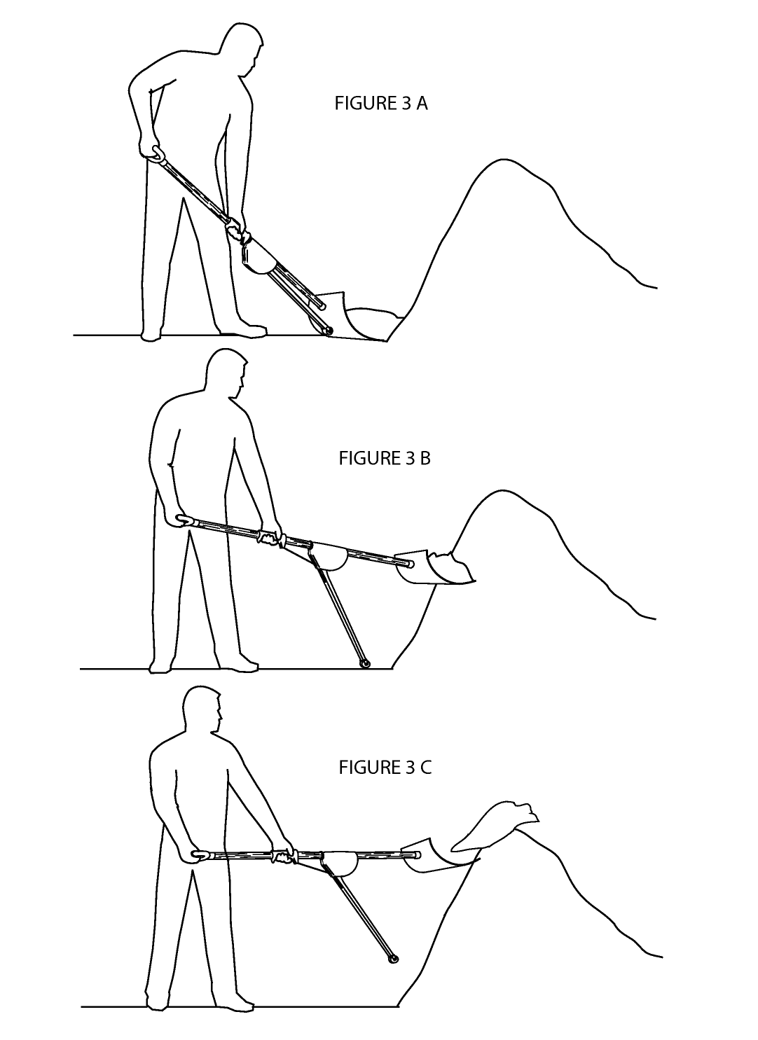

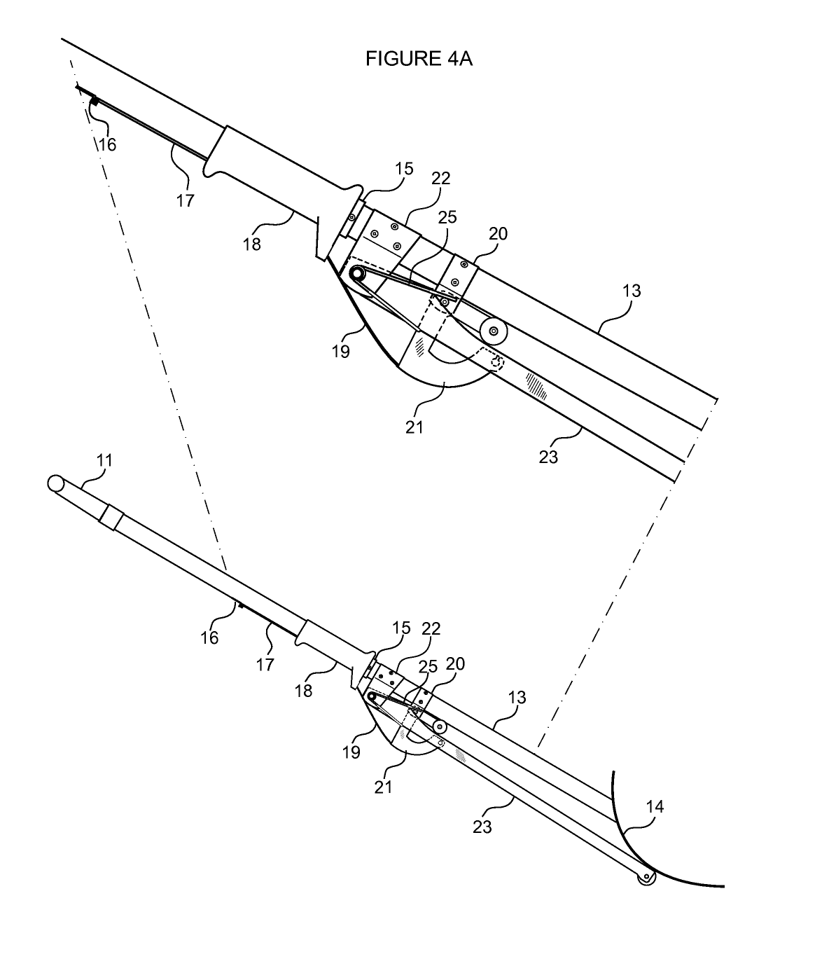

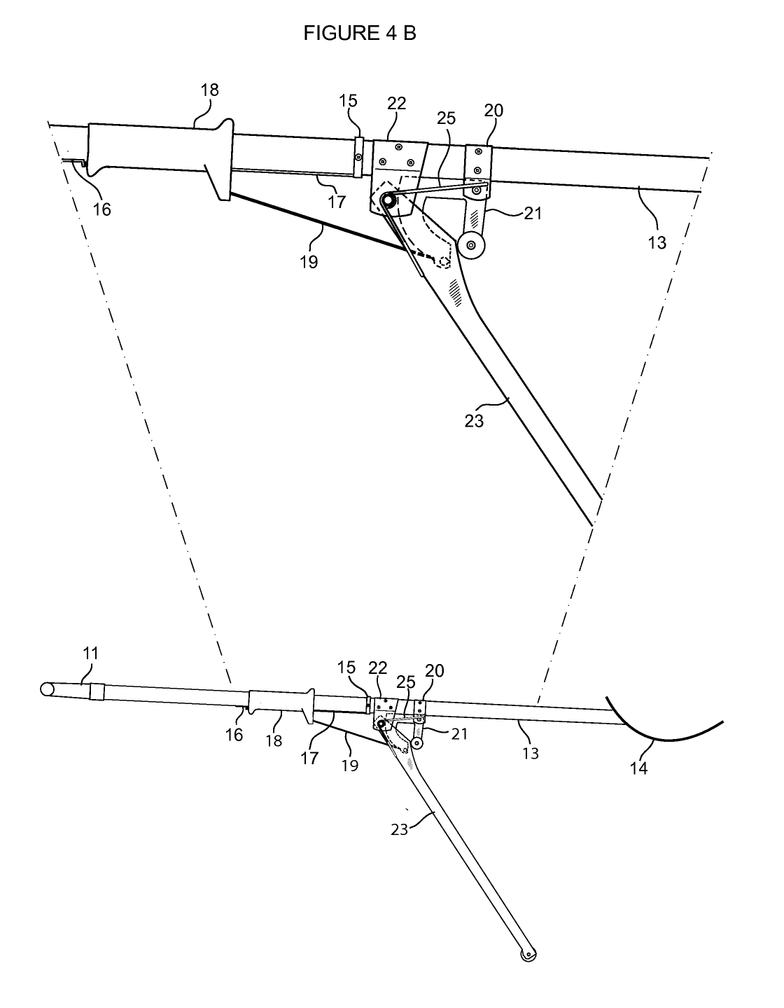

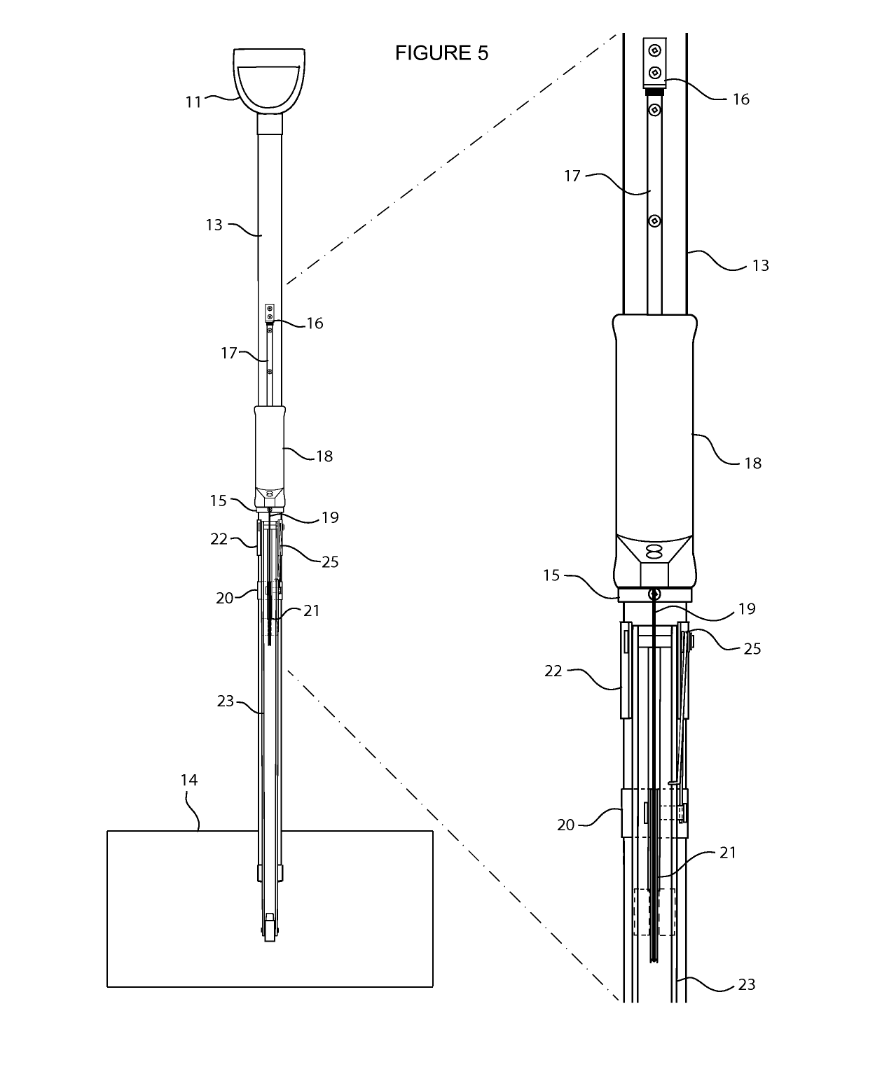

### DETAILED DESCRIPTION OF THE DRAWINGS

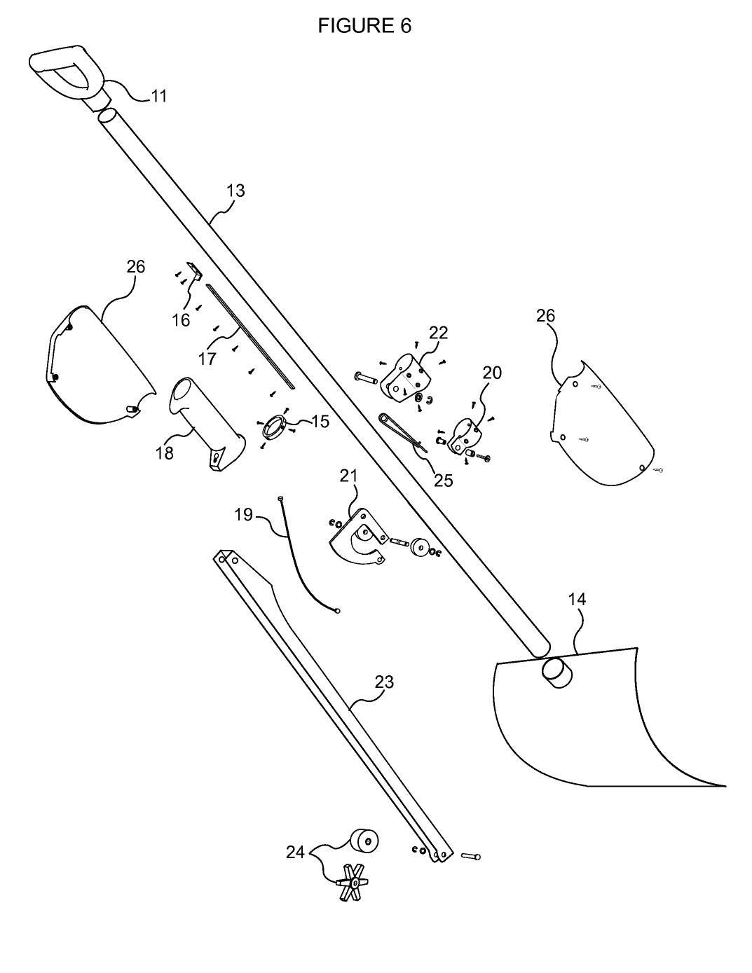

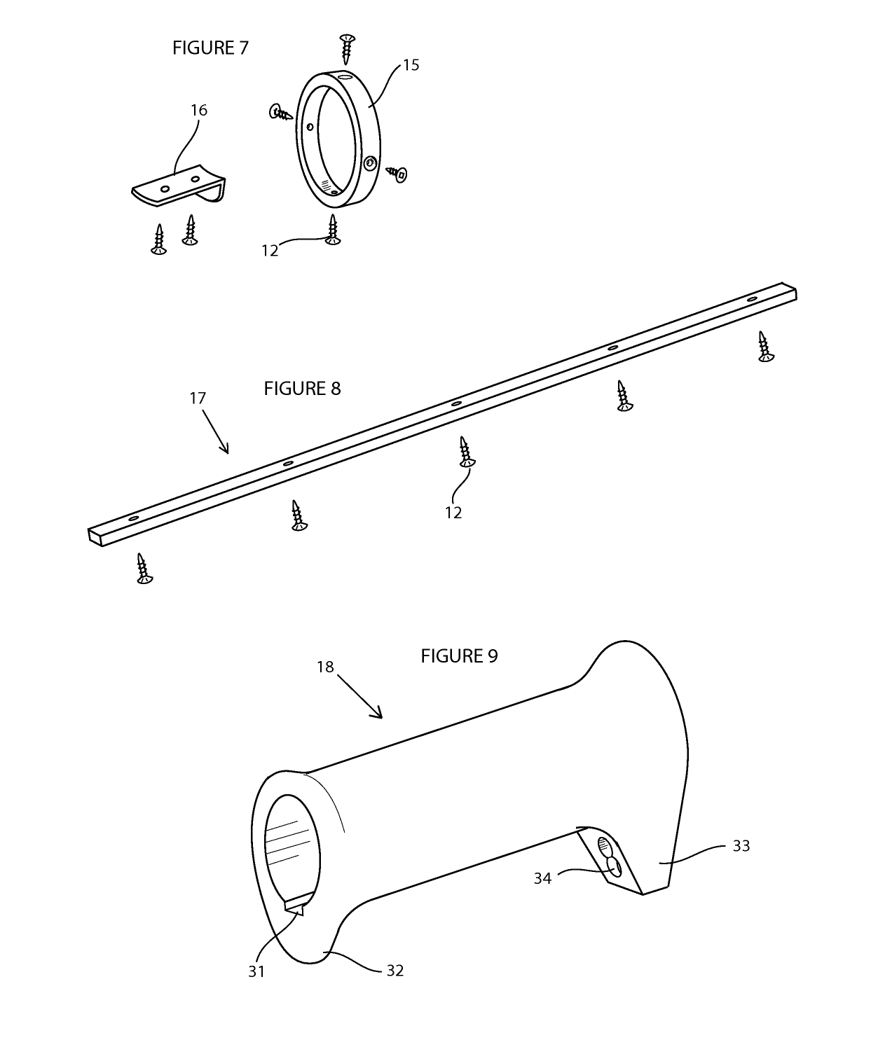

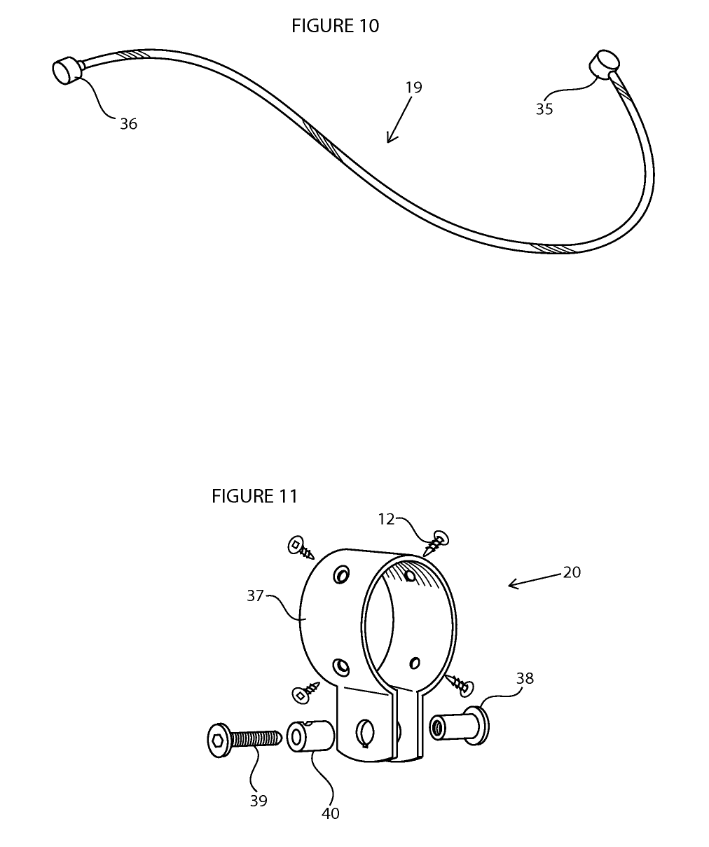

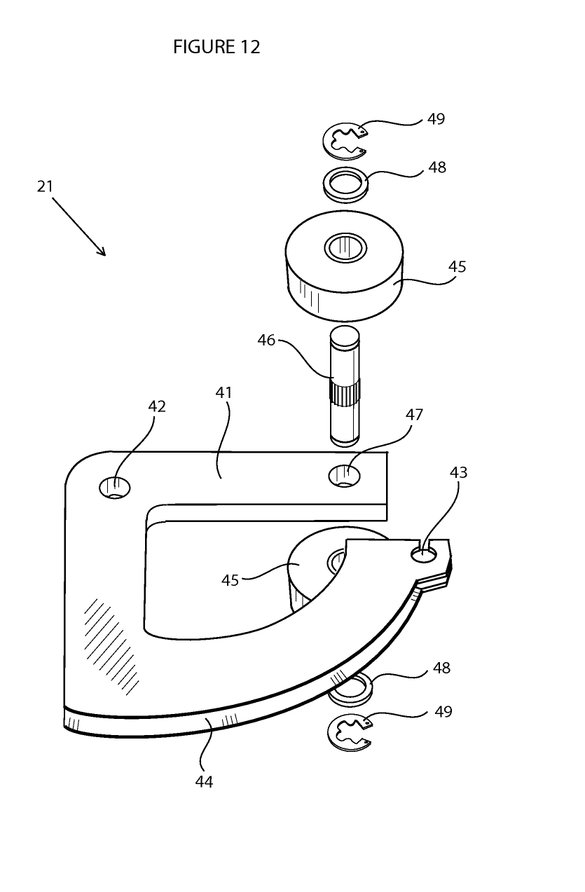

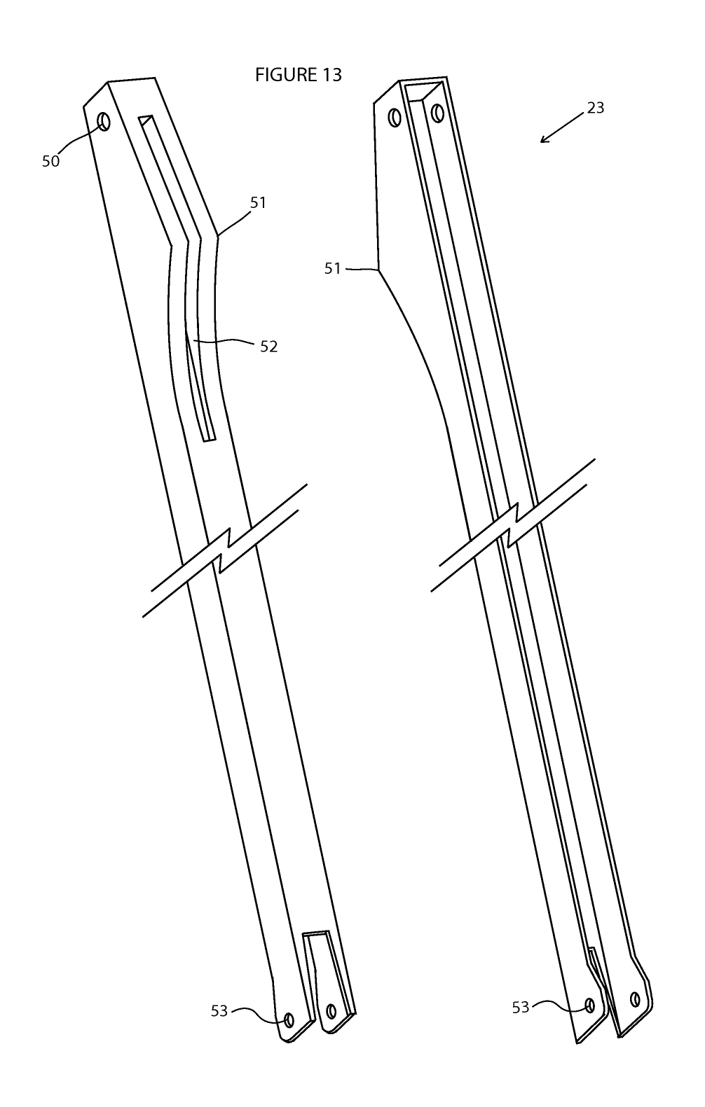

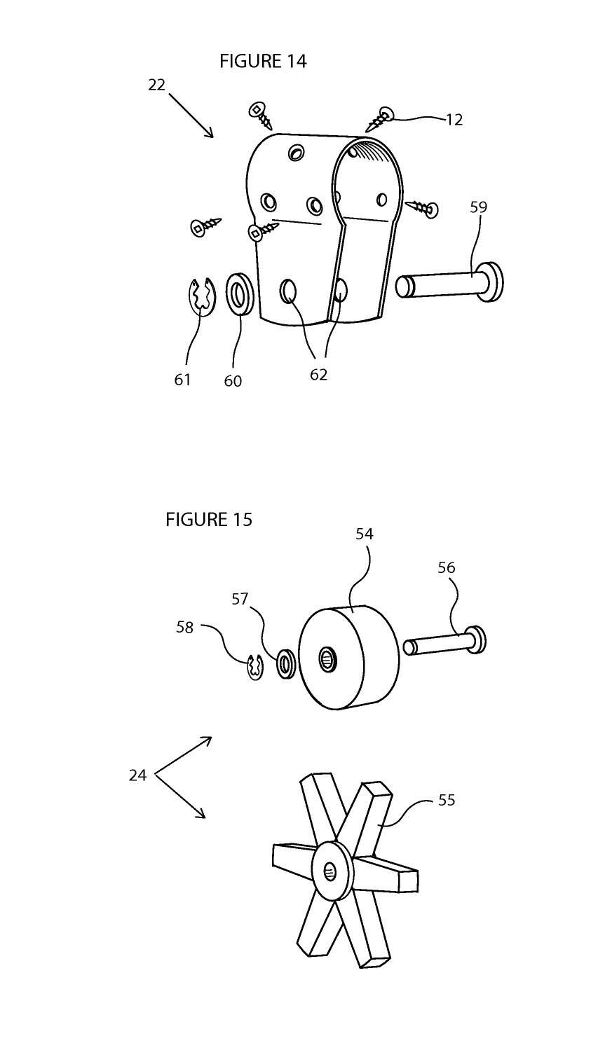

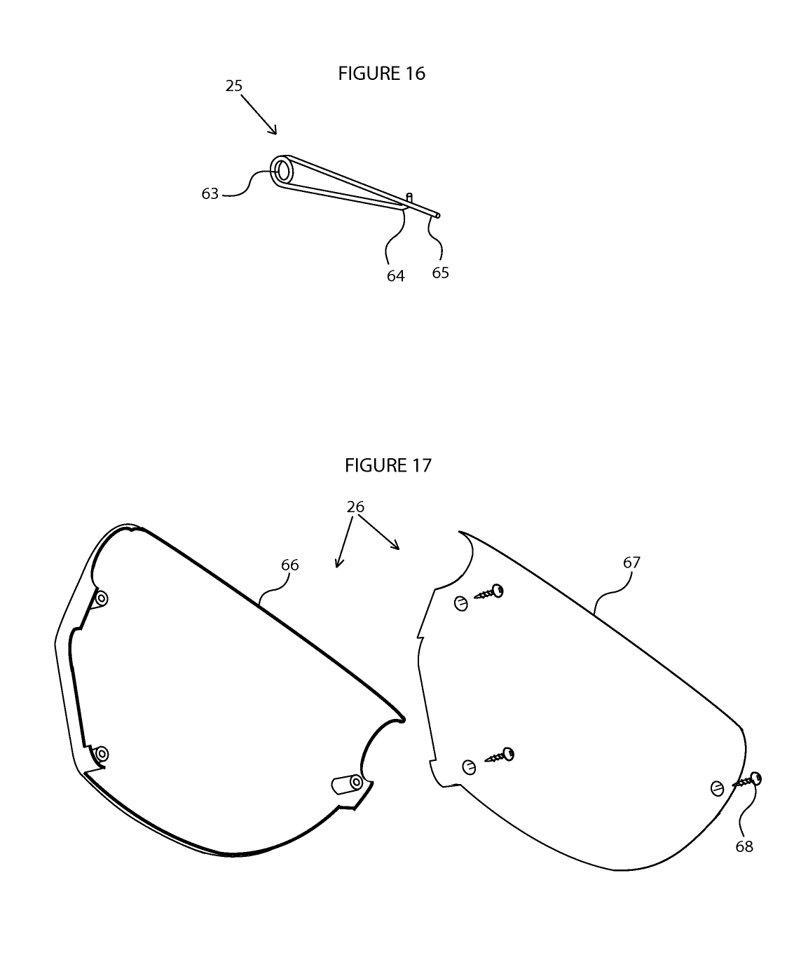

Referring in detail to the drawings in FIG. 6. Showing a shovel lifting/throwing device, having in this case, a snow shovel blade 14 for pushing and scooping material off a surface, a handle 13 for gripping by user and to receive all main components of the present invention and a D-handle 11 for gripping by user. Blade 14, handle 13 and D-handle 11 being of a conventional shovel. A set of stops 15 and 16 being shown in greater detail in FIG. 7. A guide track 17 being shown in greater detail in FIG. 8. A hand grip 18 being shown in greater detail in FIG. 9. A steel cable 19 being shown in greater detail in FIG. 10. A bracket 20 being shown in greater detail in FIG. 11. A mechanism 21 being shown in greater detail in FIG. 12. A lifting arm 23 being shown in greater detail in FIG. 13. A bracket 22 being shown in greater detail in FIG. 14. Optional wheels 24 shown in greater detail in FIG. 15. A spring 25 shown in greater detail in FIG. 16. A cover 26 shown in greater detail in FIG. 17.

FIG. 7 shows a perspective view of stops 15 and 16, being of a suitable material, typically steel, rigidly fastened to handle 13 by means 12, to restrict the range of movement along the middle section of handle 13 of hand grip 18 (described in further detail below).

FIG. 8 shows a perspective view of a guide track 17, being of a suitable material, typically steel, and to be rigidly fastened to handle 13 by means 12, to keep hand grip 18 from twisting around or encircling handle 13.

FIG. 9 shows a perspective view of a hand grip 18, being a sleeve of a suitable plastic material, able to fit over and slide up and down handle 13 for actuating mechanism 21 (described in further detail below), a downward extended section 32 at the trailing end for stopping the users hand from slipping off, a downward extended section 33 at the forward end containing a connection point 34 for cable 19 (described in further detail below) and a slot 31 for guide track 17 as described in FIG. 8.

FIG. 10 shows a perspective view of a steel cable 19, including a connecting end 35 for connecting to point 45 of mechanism 21 (described in further detail below) and a connecting end 36 for connection to point 34 of hand grip 18 described in FIG. 9.

FIG. 11 shows a perspective view of a bracket 20, including main body 37, being of suitable material, typically steel, and to be rigidly fastened to handle 13 by means 12 for pivotally fastening to mechanism 21 (described in further detail below) by means 38 and 39 with spacer 40 to rest one end of spring 25 (described in further detail below).

FIG. 12 shows a perspective view of a mechanism 21, including the main body 41, being of a suitable strong lightweight material, typically aluminium, having a connecting point 43 for a cable 19 described in FIG. 10 that runs along a machined concave channel 44 and two wheels 45 fastened by pressing axle 46 into hole 47 and securing by means 48 and 49 and hole 42 for connecting to bracket 20 described in FIG. 11. Alternatively, mechanism 21 could be affixed to the handle by any suitable means.

FIG. 13 shows perspective views of the top side and under side of a lifting arm 23, being a shaft of a suitable strong lightweight material, typically aluminium, for lifting blade 14 off the surface, with a sloped raised area 51 for achieving more lift and speed during operation, a slotted area 52 for mechanism 21 as described in FIG. 12 to fit through, holes 50 for pivotally connecting to bracket 22 (described in further detail below) and holes 53 for fastening wheels 24 (described in further detail below).

FIG. 14 shows a perspective view of a bracket 22 being of suitable material typically steel and to be rigidly fastened to handle 13 by means 12 for pivotally fastening to lifting arm 23 by aligning holes 62 to holes 50 of lifting arm 23 and using means 59,60 and 61.

FIG. 15 is a perspective view of wheels 24, wheel 54 being of a suitable materials typically hard rubber outer and steel center for use on a relatively hard smooth surface such as a driveway or sidewalk and wheel 55 being made of a suitable alloy for use on a soft or uneven surface such as gravel or soil, either wheel being fastened to lifting arm 23 by means 56,57 and 58.

FIG. 16 is a perspective view of a steel spring 25 for returning lifting arm 23 to a starting position after a lift, with area 63 fastened to bracket 22 by means 59, 60 and 61 shown in FIG. 14 and point 64 to rest under tension along bottom edge of lifting arm 23 and point 65 to rest under tension against spacer 40 shown in FIG. 11.

FIG. 17 is a perspective view of a cover 26 being of a suitable plastic material and having a left side 66 and a right side 67 and fastened together by means 68.

The applicant's shovel as described herein may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

The embodiment of this invention in which an exclusive property or privilege is claimed are defined as follows:

1. A shovel lifting/throwing device for removing material from a surface comprising;
a elongated handle having a upper end, a middle section and a lower end;
a D-handle that may be on some shovels fastened to the upper end of said handle;
a blade fastened to said lower end of said handle for pushing and scooping said material off said surface;
a lifting arm having a proximal end and a distal end, the said proximal end pivotally fastened along said handle, that when in the non-working position extends down generally parallel said handle to nearby the said lower end of said handle, the said distal end then being under said blade in the vicinity of said surface, the said distal end being able to pivot out and away from said blade, for lifting said blade and said material off said surface;
a mechanism fastened along said handle having a pulling portion and a pushing portion configured in a way so the force applied by the said pushing portion is greater than the force applied to the said pulling portion, the said pushing portion for engaging said lifting arm to pivot out said distal end of said lifting arm away from said blade into contact with said surface and lift said blade and said material off of said surface when said mechanism is actuated;
a hand grip located along said handle being able to move independent of said handle for gripping by user and actuating said mechanism, said hand grip being joined to said pulling portion of said mechanism, will actuate said mechanism to engage said pushing portion with said lifting arm to pivot out said distal end of said lifting arm into contact with said surface and lift said blade and said material up off of said surface as said hand grip is pulled up by user during the act of shovelling.

2. The shovel lifting/throwing device of claim 1 wherein the said handle, said D-handle and the said blade are of a conventional shovel.

3. The shovel lifting/throwing device of claim 1 wherein said lifting arm comprises;
a generally elongated shaft.

4. The shovel lifting/throwing device of claim 3 further comprises;
a raised sloped portion along said shaft that engages said mechanism for increasing the distance and speed at which the said distal end moves away from said blade.

5. The shovel lifting/throwing device of claim 3 further comprises;
means of receiving and pivotally attaching said proximal end along said middle section of said handle.

6. The shovel lifting/throwing device of claim 3 further comprises;
means attached to said distal end for rolling or moving along said surface.

7. The shovel lifting/throwing device of claims 3 further comprises;
a wheel or wheels attached to said distal end for rolling or moving along said surface.

8. The shovel lifting/throwing device of claims 3 further comprises;
optional wheels attached to said distal end for use on different surfaces.

9. The shovel lifting/throwing device of claims 3 further comprises;
means of returning to a non-working position after lifting and throwing said material.

10. The shovel lifting/throwing device of claims 3 further comprises;
a spring for returning to a non-working position after lifting and throwing said material.

11. The shovel lifting/throwing device of claim 1 wherein said mechanism comprises;
means attached to the said pushing portion for engaging said lifting arm.

12. The shovel lifting/throwing device of claim 11 further comprises;
a wheel or wheels attached to the said pushing portion for engaging said lifting arm.

13. The shovel lifting/throwing device of claim 11 further comprises;
means of connecting to a cable of like for joining to said hand grip.

14. The shovel lifting/throwing device of claim 11 further comprises;
means of receiving and attaching along said middle section of said handle.

15. The shovel lifting/throwing device of claim 1 wherein said hand grip assembly comprises;
a sleeve that can slide up and down said handle.

16. The shovel lifting/throwing device of claim 15 further comprises;
means for restricting said hand grip from sliding up or down said handle past its intended range of motion along said middle section of said handle.

17. The shovel lifting/throwing device of claim 15 further comprises;
means of connecting to said cable or like for joining to said pulling portion of said mechanism.

18. The shovel lifting/throwing device of claim 15 further comprises;
means for keeping said hand grip from twisting around or encircling said handle.

19. The shovel lifting/throwing device of any one of claims 1-18 wherein;
connecting the said handle in a removable way to said lifting arm, said mechanism, said hand grip and said blade to permit replacement of said hand grip, said lifting arm, said mechanism, said blade and said handle.
